(19) United States
(12) Patent Application Publication
(10) Pub. No.: US 2008/0287557 A1
(43) Pub. Date: Nov. 20, 2008

(54) APPARATUS AND METHOD FOR CONTINUOUSLY TREATING SURFACE OF WASTE RUBBER POWDER BY USING MICROWAVE

(76) Inventors: Tae Wook Yoo, Seongnam-si (KR); John Hee Hong, Seoul (KR); Beom Cheol Lee, Busan (KR); Hyun Ho Park, Yangsan-si (KR)

Correspondence Address: MORGAN LEWIS & BOCKIUS LLP;Suite 700, 2 Palo Alto Square, 3000 El Camino Real, Palo Alto, CA, 94306-2212, US

(21) Appl. No.: 12/144,346

(22) Filed: Jun. 23, 2008

Related U.S. Application Data
(62) Division of application No. 11/024,838, filed on Dec. 28, 2004.

(30) Foreign Application Priority Data
Aug. 13, 2004 (KR) 10-2004-0063897

(51) Int. Cl. C08J 11/04

(52) U.S. Cl. 521/40

(57) ABSTRACT

An apparatus continuously treats the surface of waste rubber powder by means of microwave thereby making it possible to treat the surface of waste rubber powder continuously and more efficiently. As a result, recycled rubber material has superior surface roughness and processability and the physical or chemical properties of the rubber articles are improved.

### CROSS REFERENCE TO RELATED APPLICATION

This application is based on, and claims priority to Korean Patent Application No. 10-2004-0063897, filed on Aug. 13, 2004, the disclosure of which is hereby incorporated by reference.

### TECHNICAL FIELD OF THE INVENTION

Generally, the present invention relates to an apparatus for continuously treating the surface of waste rubber powder by a microwave and a method of surface treatment by using the same. More particularly, the apparatus and method treat the surface of waste rubber powder continuously and more efficiently, thereby, providing a recycled rubber material having superior surface roughness and processability with improved physical and chemical properties.

### BACKGROUND OF THE INVENTION

Rubber is generally a polymer with elastic properties provided through vulcanization. Due to the vulcanization, rubber comes to have a thermosetting-like property, which makes it resistant to recycling through fusion. Thus, commonly used methods of recycling rubber are (i) to cleavage the chemical bonds thermally or physically for use of raw material or (ii) to pulverizing the rubber into an appropriate size for use of fillers or low grade material such as flooring material. However, the vulcanization makes it very difficult to pulverize the rubber by means of a general milling machine. Furthermore, once pulverized, the rubber has a very low interfacial adhesion with adhesives or other rubbers because of the stably vulcanized structure.

Therefore, the activation or devulcanization of the surface of the rubber is necessary for the effective recycle of the rubber. Examples of known methods of activating or devulcanizing include: a method of adding devulcanizer; a hydrolysis method; a corona discharging method; a microwave method; and radio frequency (RF) method.

However, these known methods utilize a non-continuous process, thus resulting in problems of low productivity and widely varying degrees of surface activation according to production lot. Further, due to the non-continuous process, the treatment efficiency varies widely according to the method of inputting or loading rubber. For at least theses reasons, a more efficient method of treating the surface of rubber needs to be developed.

### SUMMARY OF THE INVENTION

One aspect of the invention relates to an apparatus for continuously treating a surface of a waste rubber powder by using a microwave. The apparatus includes a supplying means that has a hopper and a feeder. The feeder continuously transports and provides a raw waste rubber powder at a predetermined rate. The apparatus also includes a surface-treating means that applies microwave to the waste rubber powder while transporting the waste rubber powder. Further included is a cooling means.

Another aspect of the present invention relates to a method for continuously treating a surface of a waste rubber powder through microwave. The method includes the steps of inputting a raw waste rubber powder in a hopper of a supplying means. Continuously providing the waste rubber powder at a predetermined rate by using a feeder. Treating a surface of the waste rubber powder by applying microwave to the waste rubber powder while transporting the waste rubber powder into a treatment chamber by means of a conveyor. Generating the microwave by a microwave generator and cooling the waste rubber powder by passing it through a cooling jacket of a cooling means.

### BRIEF DESCRIPTION OF THE DRAWINGS

The aforementioned aspect and other features of the present invention will be explained in the following detailed description, taken in conjunction with the accompanying drawings, wherein:

FIG. 1 is a schematic drawing of the apparatus according to an embodiment of the present invention;

FIGS. 2a-2c are a front view, a side view, and a top view, respectively, of a controlling member according to an embodiment of the present invention; and

FIG. 3 is a schematic drawing of cooling means according to an embodiment of the present invention.

### DETAILED DESCRIPTION OF THE EMBODIMENTS

The present invention relates to an apparatus and methods for continuously treating waste rubber powder by using microwave. The present invention efficiently recycles waste rubber powder, including chemically stable and durable ethylene-propylene-diene terpolymer (EPDM), by continuously applying microwave to crushed vulcanized EPDM powder or particles. Thereby, enabling uniformly surface-modified solid EPDM vulcanizate powder or particles. Microwave assists in giving an activated functional group to a thermally stable rubber such as EPDM. It will be appreciated by one of ordinary skill in the art that the microwave, however, should be used in a closed space due to its high energy and straight-going nature.

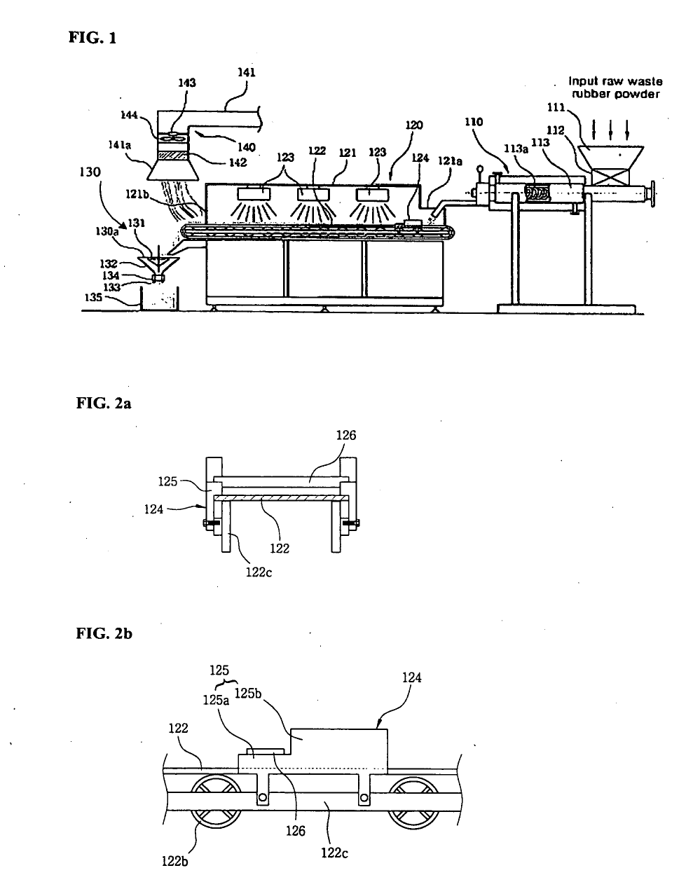

Referring to FIG. 1, an apparatus includes a supplying means 110. The supply means 110 comprising a hopper 111 and a feeder 113. The feeder 113 continuously transports and provides a raw waste rubber powder at a predetermined rate to the hopper 111. A surface-treating means 120 is also included which applies microwave to the waste rubber powder while transporting the waste rubber powder. Further included is a cooling means 130. In an alternative embodiment, the present invention further includes a discharger 140 that comprises a duct 141, an adsorption filter 142, and a motor-operated fan 144. The adsorption filter 142 and the fan 144 are equipped inside the duct 141 whereby noxious gas generated in the surface-treating means 120 is adsorbed and removed. The inhaling part 141a of the duct 141 is preferred to be equipped near the outlet 121b of the chamber 121 so that the noxious fumes are compelled to be inhaled by the motor-operated fan 144 through the inhaling part 141a, adsorbed to the adsorption filter 142, and removed to the outside.

The supplying means 110 may further comprise a mixer 112 equipped between the hopper 111 and the feeder 113 in order to prevent a lumping caused by gravity. The mixer 112 can be an agitator-type or flexible-wall-type mixer, for example. The feeder 113 may have various shapes, such as a vibration-type feeder, but preferably is a screw-type feeder that can transport the waste rubber powder at a constant rate and prevent a lumping phenomenon. The feeder 113 should transport the waste rubber powder having a diameter of not less than about 80 μm and not more than about 1,000 μm, and the transportation amount of the waste rubber powder may be controlled to be not less than about 5 and not more than about 20 kg/hr (precision: ±2.5%). Preferably, the waste rubber is transported at not less than about 15 and not more than about 20 kg/hr.

If the rate is below about 5 kg/hr, the microwave-mediated devulcanization may be induced even inside the waste rubber powder. If the devulcanization is induced inside the waste rubber a plasticization of the rubber on the surface of the conveyor 122 of surface-treatment means 120 occurs and eventually induces a carbonization of the surface of the conveyor 122. On the contrary, a transportation rate above 20 kg/hr is less preferred because it is difficult to make the uniform treatment of surface of the waste rubber powder.

The surface-treating means 120 includes a horizontal chamber 121 comprising an inlet 121a and an outlet 121b at each end. A conveyor 122 transports the waste rubber powder from the inlet 121a to the outlet 121b. A microwave generator 123 is equipped inside the chamber 121, whereby microwave is generated and applied to the waste rubber powder.

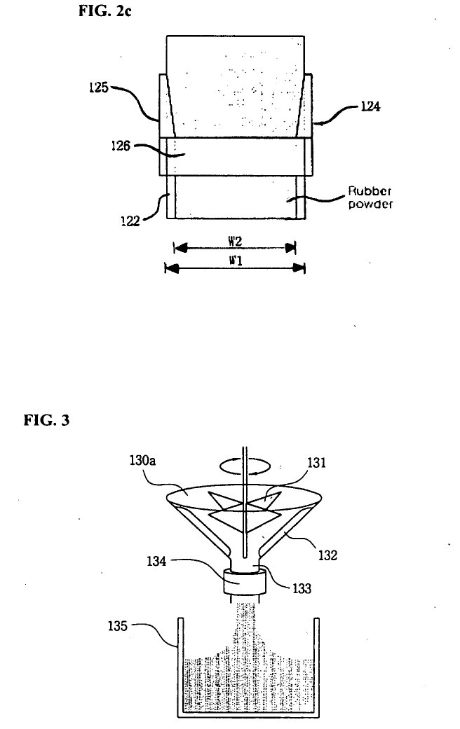

The surface-treating means 120 according to another aspect of the present invention includes a controlling member 124 on the conveyor 122 at a part near the inlet 121a, whereby the waste rubber powder is surface-treated and transported in predetermined thickness and width. Referring to accompanying FIGS. 2a-2c, unexplained member 124 is a controlling member 124. The controlling member 124 comprises two side walls 125 and a guiding member 126, wherein each of lower parts of the side walls 125 is fixed to right and left frames 122c of the conveyor 122, respectively. Each of the guiding member 126 is connected to each of the side walls 125 in a manner that the waste rubber powder is passed below the guiding member 126. The waste rubber powder is controlled to have a predetermined thickness and width according to the respective height of the side walls 125 and length of the guiding member 126.

Further, the side wall 125 can have a front side wall 125a and a rear side wall 125b. The rear side wall 125b is higher than the front side wall 125a so that the rear side wall 125b may prevent unpassed rubber powder from flowing over the side walls 125. The width between the side walls 125 (W2 in FIG. 2c) is preferred to be about 80% of the width of the frames 122c of the conveyor 122 (W1) in order to prevent the loss of rubber powders. That is, the guiding member 126 (W2) is preferred to have an inner width (W2 in FIG. 2c) of about 80% of the width of the frames 122c of the conveyor 122 (W1 in FIG. 2c). Therefore, the waste rubber powder is controlled to pass below the guiding member 126, thus having a predetermined thickness and width, thereby enabling uniformity in surface treatment and reproduction in the process.

The height of the guiding member 126 may be changed according to the power of microwave generator 123 and the amount of supplied rubber powder. According to one aspect of the present invention, the height (i.e., the distance from conveyor surface to the lower surface of the guiding member 126) is preferably about 0.5 mm. If the height is below about 0.5 mm, the uniform treatment of rubber powder may be obtained only below about 5 kg/hr of supplied amount of rubber powder, thus lacking economical efficiency. On the contrary, when the height is above about 20 kg/hr, the guiding member 126 may cause uniform height of the rubber powder only when the amount of supplied rubber powder is above about 15 kg/hr, which causes loss of rubber powder due to the oversupply. Meanwhile, it is preferred to maintain the temperature inside the chamber 121 at not less than about 150 and not more than about 250° C. so that the surface of rubber powder become uniformly treated.

Rubber powder is supplied from the feeder 113 onto the continuously moving conveyor 122, thus enabling uniform treatment of the surface of the rubber powder. Further, a plurality of microwave generators 123 may be equipped at appropriate places inside chamber having open inlet 121a and outlet 121b. Preferably the surface of the rubber powder is activated by the microwave over a short period of time in the chamber, the temperature of which is controlled to be in a range of not less than about 150 and not more than about 250° C., more preferably not less than about 150 and not more than about 200° C.

If the temperature is below about 150° C., it is difficult to maintain the rubber at the preferable temperature range. It is even more difficult to maintain the temperature of the rubber at the inside of the material near the inlet 121a and the outlet 121b at the preferred temperature. Further, the efficient surface modification may not be performed in the case of EPDM that is heat-resistant at 210-230° C. On the contrary, if the temperature is above about 250° C., thermal degradation can occur even in the main chain of the rubber and the rubber may not be useful as recycling material at this point. Because the preferred temperature in the chamber 121 raises to about 250° C., a belt of the conveyor 122 is preferred to be made of thermally stable polymer such as, for example, Teflon™.

According to one aspect of the present invention, the microwave is applied to the waste rubber powder at a power of lower than about 3 kW, preferably not less than about 0.5 kW and not more than about 2 kW. Microwave below the power of about 0.5 kW may not efficiently treat the surface of the waste rubber powder. Especially, the carbon-sulfur bond in EPDM, which has low loss factor, might not be efficiently cleaved due to low absorption of microwave. On the contrary, if the power is above about 2 kW, the temperature abruptly increases inside the chamber 121 and the main chain (carbon-carbon) may be cleaved. Especially, if the chamber 121 is maintained in a range of similar or equivalent temperature to the vulcanization temperature or an internal energy, an inverse reactions, such as, revulcanization by remaining vulcanizate and cleavage of main chain, thus preventing the rubber from having desired property after surface treatment.

According to another aspect of the present invention, a plurality of, preferably 1-4, and more preferably 2-3 microwave generators 123 may be used according to the nature of the target raw rubber powder. For the uniform treatment, a single microwave generator is not preferred due to the straight-going nature of the microwave. In contrast, more than 4 generators is not preferred considering too low efficiency and too high temperature inside the chamber 121.

Further, it is preferred that the waste rubber powder is transported through the chamber 121 for not less than about 10 seconds and not more than about 120 seconds, more preferably not less than about 50 seconds and not more than about 60 seconds. Either below about 10 seconds or above about 120 seconds are not preferred considering efficient surface treatment or thermal degradation, respectively.

Meanwhile, the surface-treated rubber powder contains high internal energy and should be promptly cooled such that thermal degradation does not occur. Thus, it is preferred to position the cooling means 130 near the outlet 121b of the chamber 121. Further, according to another aspect of the present invention, the cooling means 130 comprises a funnel 130a, a mixer 131, and a cooling jacket 132 to increase cooling efficiency. The inner wall of the funnel 130a is preferred to be made of a stable compound such as, for example, Teflon™, which has good heat and chemical resistance. This is because of exposure the funnel 130a experiences to the high temperature of the surface-treated rubber powder and a large amount of sulfur-based vulcanizer remaining on the surface of the surface-treated rubber powder.

The cooling jacket 132 is preferably equipped on an inner wall of the funnel 130a in order to maintain roughly 50-60° C. about the inner wall. The cooling system is also preferred to be a water-cooling system because water is easy to treat and chemically stable as a cooling medium.

The mixer 131 is preferably equipped in the passing route of the surface-treated rubber powder, and is also preferred to be a vertical impeller type mixer that may function vertically as well as horizontally to increase the cooling efficiency. The cooled rubber powder passes an outlet pipe 133 and is collected in a container 135. A rotary valve 134 is equipped to the outlet pipe 133.

An apparatus according to another aspect of the present invention includes a discharger 140 that comprises a duct 141, an adsorption filter 142, and a motor-operated fan 144. The adsorption filter 142 and the fan 144 are equipped inside the duct 141, whereby noxious gas generated in the surface-treating means 120 is adsorbed and removed.

To verify the effectiveness in surface activation, experiments have been performed using EPDM waste rubber with the lowest loss factor and are as set forth hereunder. A microwave power and a passage time were selected in the preferred range for solid EPDM vulcanized powder or particles, as disclosed above, wherein the parameters for this experiment were a power of lower than about 1.5 kW and a speed of lower than about 120 seconds.

| | | Comparative | | |
|---|---|---|---|---|
| | | Example | Example 1 | Example 2 |
| Amount | Raw rubber powder | 100 | 100 | 100 |
| | Non-modified (0.1 mm) | 20 | | |
| | Modified (0.1 mm) | | 20 | |
| | Modified (0.3 mm) | | | 20 |
| | Treatment condition | | 0.6, 60 | 0.6, 60 |
| | (kW, sec) | | | |
| | Solubility (%), powder | 22 | 27 | 26 |
| | only | | | |
| Physical | Hardness (Hs A) | 70 | 71 | 70 |
| property | Tensile strength (kg/cm²) | 97 | 106 | 105 |
| | Elongation ratio (%) | 230 | 255 | 242 |
| | Surface roughness | Bad | Good | Average |

Waste rubber powders that were continuously treated by the microwave according to the present invention were used in Examples 1 and 2, while non-modified rubber powder was used in the Comparative Example, shown in Table 1 above.

To prepare the rubber compounds, 20 parts by weight of modified rubber powders (Examples 1 & 2) or non-modified rubber powder (Comparative Example) were admixed with 100 parts by weight of EPDM (ethylene propylene diene rubber). In Example 2, 100 parts by weight of NR (natural rubber) was used instead of 100 parts by weight of EPDM. Other widely-used additives, for example, oils such as aromatic-based, paraffin-based and naphthene-based oils, processing aids, vulcanizers, vulcanizing accelerators, anti-oxidants were also added and admixed for more than 2 hours by using a mixing machine for rubber.

The prepared rubber compounds were extruded by using Haake Extuder™, and the morphology and other physical properties of the compounds were observed. As shown in the Table 1, physical properties such as surface roughness, tensile strength, and elongation ratio were improved in the compounds according to the present invention as compared with that of Comparative Example.

As will be appreciated by one of ordinary skill in the art, the technique of evaluating surface roughness is not settled, and thus, the surface roughness was determined by the amenity quality (or emotional quality) method. According to the amenity quality evaluation, it is preferred to contain about 20 parts by weight of EPDM powder on a basis of the weight of raw rubber in case of about 5% vulcanized solid EPDM powder, according to the present invention. Further, the amenity quality is verified to be related to the diameter of the vulcanized rubber powder. More particularly the amenity quality is verified to be deteriorated when the size is above about 0.15 mm. Conclusively, about 20 parts by weight of EPDM powder (on a basis of the weight of raw rubber) is preferred to be contained in case of about 5% vulcanized solid EPDM powder according to the present invention, and the smaller sized rubber powder is preferred for the better amenity quality. Further, the tensile strength and the elongation ratio were also improved by more than 10% in the case of the compounds according to the present invention as compared with that of Comparative Example.

1-11. (canceled)

12. A method for continuously treating a surface of a waste rubber powder by using microwave, the method comprising:
inputting a waste rubber powder into a hopper of a supplying means;
continuously providing waste rubber powder at a predetermined rate by using a feeder,
treating a surface of the waste rubber powder by applying microwave to the waste rubber powder while transporting the waste rubber powder into a treatment chamber by means of a conveyor, wherein the microwave is generated by a microwave generator, and
cooling the waste rubber powder by passing the waste rubber powder through a cooling jacket of a cooling means.

13. The method of claim 12, wherein the feeder provides the waste rubber powder having a diameter of not less than about 80 μm and not more than about 1,000 μm at a rate of not less than about 5 kg/hr and not more than about 10 kg/hr.

14. The method of claim 12, wherein a temperature inside the chamber is maintained at not less than about 150° C. and not more than about 250° C.

15. The method of claim 12, wherein the microwave is applied to the waste rubber powder at a power of lower than about 3 kW.

16. The method of claim 12, wherein the waste rubber powder is transported through the chamber for a passage time of not less than about 10 seconds and not more than about 120 seconds.

17. The method of claim 12, wherein a temperature of the cooling jacket is maintained at not less than about 60° C. and not more than about 80° C.

18-20. (canceled)
